(19) United States
(12) Patent Application Publication
(10) Pub. No.: US 2010/0072973 A1
(43) Pub. Date: Mar. 25, 2010

(54) Voltage Converter

(75) Inventors: Chow-Peng Lee, Sinshih Township (TW); Aung Aung Yinn, Sinshih Township (TW); Tyng-Yang Chen, Sinshih Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX ANALOGIC, INC., Sinshih Township (TW)

(21) Appl. No.: 12/236,100

(22) Filed: Sep. 23, 2008

(51) Int. Cl. G05F 3/16

(52) U.S. Cl. 323/315

(57) ABSTRACT

A voltage converter to convert a high voltage to a low voltage is provided. The voltage converter comprises: a current mirror, a current bias, a plurality of loads and a low voltage output. The current mirror comprises a first PMOS and a second PMOS, wherein the source of the first PMOS and the second PMOS receive a high voltage input which is a supply voltage of the current mirror, and the gate of the first PMOS is connected to the drain of the first PMOS. The current bias is connected between the drain of the first PMOS and a ground potential. The plurality of loads are parallel connected between the drain of the second PMOS and the ground potential. And the low voltage output connected to the drain of the second PMOS.

### BACKGROUND

1. Field of Invention

The present invention relates to a voltage converter. More particularly, the present invention relates to a voltage converter to convert a high voltage to a low voltage.

2. Description of Related Art

In current integrated circuit design, some circuits have only high voltage power supply input. In order to provide the low voltage modules with less area in the integrated circuit an accurate reference voltage, i.e. a low voltage, a voltage converter is necessary to transfer the high voltage power supply into a lower voltage. However, the additional module to generate the reference voltage will certainly make the area of the integrated circuit larger. Also, the semiconductor devices with different fabrication process tend to affect the accuracy of the transferred voltage.

Accordingly, what is needed is a voltage converter to generate an accurate low voltage from a high voltage with a small area to overcome the above issues. The present invention addresses such a need.

### SUMMARY

A voltage converter to convert a high voltage to a low voltage is provided. The voltage converter comprises: a current mirror, a current bias, a plurality of loads and a low voltage output. The current mirror comprises a first PMOS and a second PMOS, wherein the source of the first PMOS and the second PMOS receive a high voltage input which is a supply voltage of the current mirror, and the gate of the first PMOS is connected to the drain of the first PMOS. The current bias is connected between the drain of the first PMOS and a ground potential. The plurality of loads are parallel connected between the drain of the second PMOS and the ground potential. And the low voltage output connected to the drain of the second PMOS.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a voltage converter of the first embodiment of the present invention;

FIG. 2 is a voltage converter with a buffer of another embodiment of the present invention; and

FIG. 3 is a voltage converter with a low drop-out regulator of yet another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

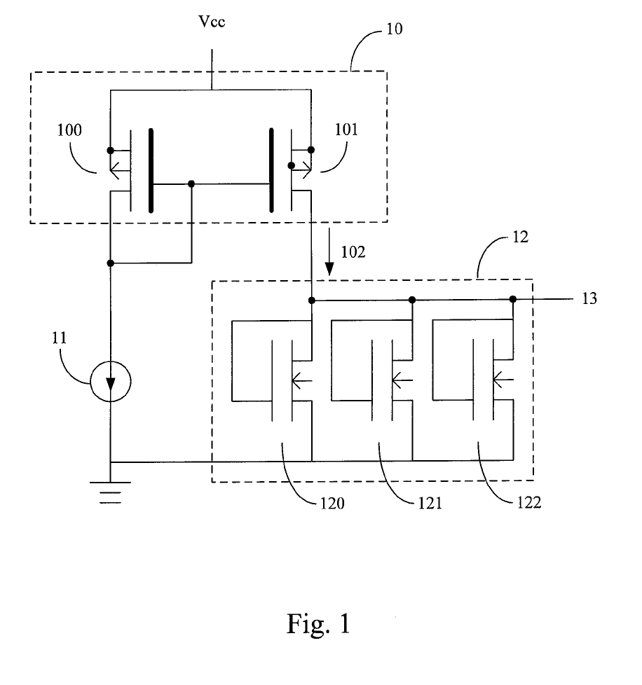

Please refer to FIG. 1, a voltage converter 1 of the first embodiment of the present invention. The voltage converter 1 comprises a current mirror 10, a current bias 11, a plurality of loads 12 and a low voltage output 13. The current mirror 10 comprises a first PMOS 100 and a second PMOS 101, wherein the source of the first PMOS 100 and the second PMOS 101 receive a high voltage input Vcc that is a supply voltage of the current mirror 10, and the gate of the first PMOS 100 is connected to the drain of the first PMOS 100. In order to endure the high voltage input Vcc, the first PMOS and the second PMOS are both high voltage PMOS (HVPMOS) that can endure high voltage.

The current bias 11 is connected between the drain of the first PMOS 100 and a ground potential. The loads 12 in the present embodiment comprise three enhancement NMOS 120, 121 and 122. The three enhancement NMOS 120, 121 and 122 are parallel connected between the drain of the second PMOS 101 and the ground potential. And the low voltage output 13 is connected to the drain of the second PMOS 101. Through the current mirror 10, a current 102 is generated according to the current bias 11 to provide the load 12 a stable current. Further, the three enhancement NMOS 120, 121 and 122 are low voltage NMOS (LVNMOS). The high voltage from Vcc is split equally by the three enhancement NMOS 120, 121 and 122. Thus, a lower voltage at the low voltage output 13 is generated.

In other embodiment, the number of the NMOS of the loads 12 can be different to generate a different value of low voltage output 13. If more NMOS are connected in parallel, the high voltage is split by more NMOS. Therefore a lower voltage output is generated. If less NMOS are connected in parallel, the high voltage is split by less NMOS. Therefore the voltage output generated at the low voltage output 13 is higher. Yet in another embodiment, the loads 12 can comprise a plurality of resistors to generate the low voltage output. But it's noticed that the area of the resistor is much larger than the NMOS, and the fabrication process of the NMOS is much easier to control as compared to the resistor.

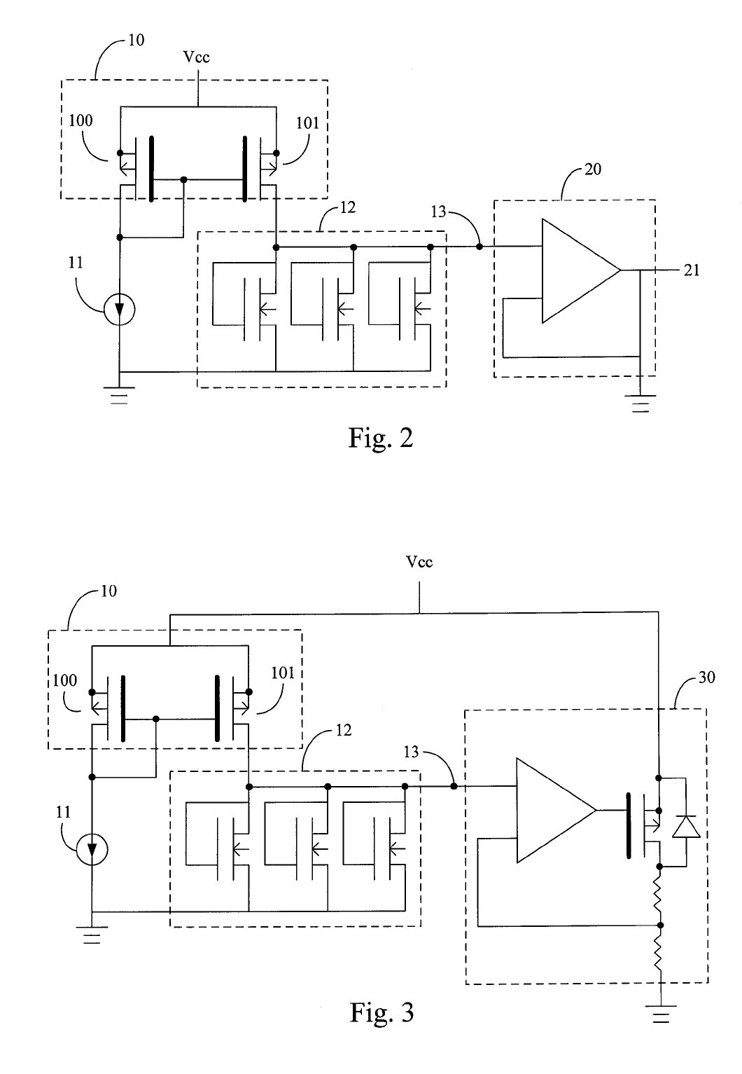

In order to generate a more stable reference voltage to the low voltage module in an integrated circuit, a buffer 20 can be connected to the low voltage output 13 to generate the reference voltage 21 as depicted in FIG. 2. Furthermore, the low voltage output 13 can further connects to a reference voltage input of a low drop-out regulator 30 as depicted in FIG. 3, wherein the supply voltage of the low drop-out regulator receives the high voltage input Vcc of the current mirror 10 to generate a high accuracy low voltage power supply 32.

The voltage converter of the present invention can generate an accurate low voltage from a high voltage due to the stable current bias and the voltage split of the loads, and the low voltage NMOS of the loads have a small area size to accomplish the voltage transfer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A voltage converter to convert a high voltage to a low voltage comprising:
a current mirror comprising a first PMOS and a second PMOS, wherein the source of the first PMOS and the second PMOS receive a high voltage input which is a supply voltage of the current mirror, the gate of the first PMOS is connected to the drain of the first PMOS;
a current bias connected between the drain of the first PMOS and a ground potential;
a plurality of loads parallel connected between the drain of the second PMOS and the ground potential; and
a low voltage output connected to the drain of the second PMOS.

2. The voltage converter of claim 1, wherein the plurality of loads are a plurality of enhancement NMOS.

3. The voltage converter of claim 2, wherein the plurality of enhancement NMOS are low voltage NMOS (LVNMOS).

4. The voltage converter of claim 1, wherein the first PMOS and the second PMOS are high voltage PMOS (HVPMOS).

5. The voltage converter of claim 1, wherein the low voltage output further connects to a reference voltage input of a low drop-out regulator, wherein the supply voltage of the low drop-out regulator receives the high voltage input of current mirror.

6. The voltage converter of claim 1, wherein the low voltage output further connects to a buffer to generates a reference voltage.

7. The voltage converter of claim 1, wherein the voltage level of the low voltage output depends on the number of the loads.
